(19) United States
(12) Patent Application Publication
(10) Pub. No.: US 2017/0256161 A1
(43) Pub. Date: Sep. 7, 2017

(54) REMOTELY-ACTIVATED ILLUMINATING SAFETY DEVICES AND RELATED METHODS

(71) Applicants: M. Bennett Shaffer, St. George, UT (US); Tanzy Leah Shaffer, St. George, UT (US)

(72) Inventors: M. Bennett Shaffer, St. George, UT (US); Tanzy Leah Shaffer, St. George, UT (US)

(21) Appl. No.: 15/373,338

(22) Filed: Dec. 8, 2016

Related U.S. Application Data
(60) Provisional application No. 62/239,186, filed on Oct. 8, 2015.

(51) Int. Cl. G08G 1/005; G08G 1/07

(52) U.S. Cl. CPC G08G 1/005; G08G 1/07

(57) ABSTRACT

Safety systems for enhancing the visibility of pedestrian crosswalk traffic control devices and related methods. In some embodiments, a plurality of crosswalk safety modules is provided, each of which is configured to be removably coupled with a separate crosswalk traffic control device. Each of the plurality of crosswalk safety modules may comprise one or more lights and/or one or more speakers or alarms, configured to, upon actuation, improve the visibility of a crosswalk traffic control device coupled with the accompanying crosswalk safety module to motorists. The system may further comprise a remote control configured to generate a signal for remote operation of each of the plurality of crosswalk modules. Each of the plurality of crosswalk modules is preferably configured such that actuation of the remote control results in coordinated operation of the lights and/or sounds associated with the plurality of crosswalk modules.

### RELATED APPLICATIONS

This application claims the benefit under 35 U.S.C. §119(e) of U.S. Provisional Patent Application No. 62/239,186 filed Oct. 8, 2015 and titled “REMOTELY ACTIVATED ILLUMINATING SAFETY DEVICE WITH SOUND NOTIFICATION,” which application is incorporated herein by reference in its entirety.

### SUMMARY

Various embodiments of traffic safety devices and related methods are described herein. In preferred embodiments and implementations, such devices and methods may provide lighting and/or sound notification features designed to reduce pedestrian injury and death in crosswalk zones.

The U.S. Department of Transportation National Highway Traffic Safety Administration (NHTSA) reported that in the calendar year of 2012, in the United States, 4,743 pedestrians were killed, on average one every 2 hours. The U.S. Center for Disease Control (CDC) reported that from 1993-2008, 120 Crossing Guards died on the job in the U.S. The World Health Organization reports over 270,000 global annual pedestrian deaths.

A pedestrian struck by a vehicle at 40 miles per hour has only a 15% survival rate. By slowing the traffic down, a pedestrian struck by a vehicle, for example, at 20 miles per hour, has a 95% survival rate.

There remains a need for enhanced safety and visibility in crosswalk zones and other areas beyond currently available technologies. Thus, one or more of the inventive embodiments and implementations disclosed herein seek to improve upon one or more deficiencies of the prior art.

Some embodiments may comprise a plurality of remotely controlled, internally communicating, illuminating pedestrian safety devices, in some embodiments with sound notification. Prior to use, each device may be attached by a user, for example, to a traffic safety device, such as a traffic cone/delineator tube, warning sign, barricade, traffic sign, or the like.

Prior to or upon a user entering and/or upon exiting a crosswalk zone, a user may activate and deactivate the device(s), such as by way of a wireless remote control, surface mounted actuator, sensor switching, or another type of surface-mounted switch, program, or the like. Some embodiments may be configured to produce various colors and combinations of light(s) patterns, shapes, symbols, words, while flashing at a predetermined (in some embodiments, programmable) flash rate, total flash cycle, solid illumination, or any combination, possibly while emitting a sound notification, which, in some embodiments, may be coordinated with the light display.

The features, structures, steps, or characteristics disclosed herein in connection with one embodiment, or one implementation, may be combined in any suitable manner in one or more alternative embodiments or implementations.

### BRIEF DESCRIPTION OF THE DRAWINGS

Non-limiting and non-exhaustive embodiments of the disclosure are described, including various embodiments of the disclosure with reference to the figures, in which:

FIG. 1A depicts an embodiment of the invention coupled with a portable traffic safety cone;

FIG. 1B depicts an embodiment of the invention coupled with a portable traffic delineator tube;

FIG. 1C depicts an embodiment of the invention coupled with a portable pedestrian crosswalk sign;

FIG. 1D depicts an embodiment of the invention coupled with a fixed pedestrian crosswalk sign;

FIG. 2A depicts a wireless remote control according to some embodiments of the invention;

FIG. 2B depicts a remote control according to other embodiments coupled with a fixed pedestrian crosswalk sign;

FIG. 3 depicts a crosswalk zone having a plurality of crosswalk safety modules arranged along one of the crosswalks of the crosswalk zone;

FIG. 4A is a perspective view of a housing of a crosswalk safety module according to some embodiments;

FIG. 4B is a first perspective view depicting various internal components of a crosswalk safety module according to some embodiments;

FIG. 4C is a second perspective view of the embodiment of FIG. 4B taken from a side opposite to the side depicted in FIG. 4B;

FIG. 5A is an upper perspective view of a housing of a crosswalk safety module according to other embodiments;

FIG. 5B is a lower perspective view of the housing of FIG. 5A;

FIG. 6A is a perspective view of another housing of a crosswalk safety module according to still other embodiments;

FIG. 6B is a perspective view of the housing of FIG. 6A with visors and a modular coupling element;

FIG. 6C is a perspective view of a modular coupling element for use with various crosswalk safety modules described herein;

FIG. 7A is a bottom plan view of an embodiment of a crosswalk safety module;

FIG. 7B is a bottom plan view of an alternative embodiment of a crosswalk safety module having an opening for receipt of a modular coupling element and/or a crosswalk traffic control device;

FIG. 8A is a perspective view of an alternative modular coupling element for use in connection with some of the crosswalk safety modules described herein;

FIG. 8B is a perspective view of the modular coupling element of FIG. 8A shown coupled with a crosswalk safety module according to some embodiments;

FIG. 8C depicts a crosswalk safety module comprising the modular coupling element of FIG. 8A coupled with a portable pedestrian crosswalk sign; and

FIG. 9 is a schematic diagram illustrating the various components and wiring schematics of certain preferred embodiments.

### DETAILED DESCRIPTION OF THE INVENTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

While the various embodiments of the present invention have been described and illustrated in terms of certain specific embodiments, those of ordinary skill in the art will understand and appreciate that it is not so limited. Additions to, deletions from, and modifications to these specific embodiments may be effected without departing from the scope of the invention as defined herein. Furthermore, features and elements from one specific embodiment may be likewise applied to another embodiment without departing from the scope of the invention as defined herein. Various modifications and adaptations of the embodiments described herein will therefore, after receiving the benefit of this disclosure, be apparent to those of ordinary skill in the art.

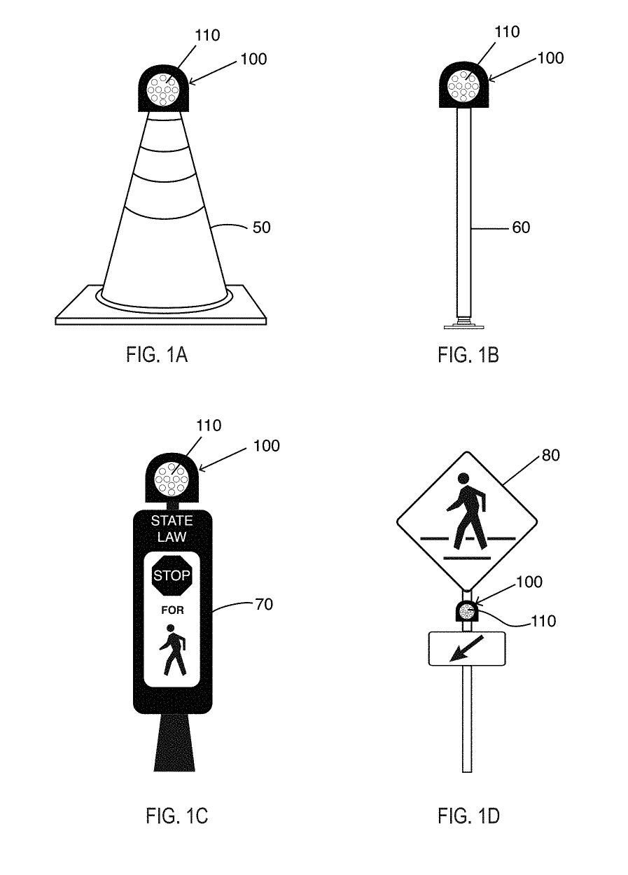

FIG. 1A depicts an embodiment of a crosswalk safety module 100 comprising a light assembly 110 comprising a light configured to provide a distinct visual notice to vehicles in or near a crosswalk. Crosswalk safety module 100 is shown coupled with a crosswalk traffic control device, namely, a portable traffic safety cone 50. As will be described in greater detail below, crosswalk safety module 100 is preferably a portable device that is configured to be removably coupled with traffic safety cone 50 and/or other crosswalk traffic control devices.

FIG. 1B depicts crosswalk safety module 100 coupled with an alternative crosswalk traffic control device, namely, a portable traffic delineator tube 60.

FIG. 1C depicts crosswalk safety module 100 coupled with another alternative crosswalk traffic control device, namely, a portable pedestrian crosswalk sign 70.

One or more of the various crosswalk safety modules described herein may also, or alternatively, be configured to couple with fixed crosswalk traffic control devices. Thus, FIG. 1D depicts crosswalk safety module 100 coupled with a fixed pedestrian crosswalk sign 80. As described below, in some embodiments, one or more magnets may be used to allow a user to selectively couple and decouple the crosswalk safety module 100 from a particular crosswalk traffic control device.

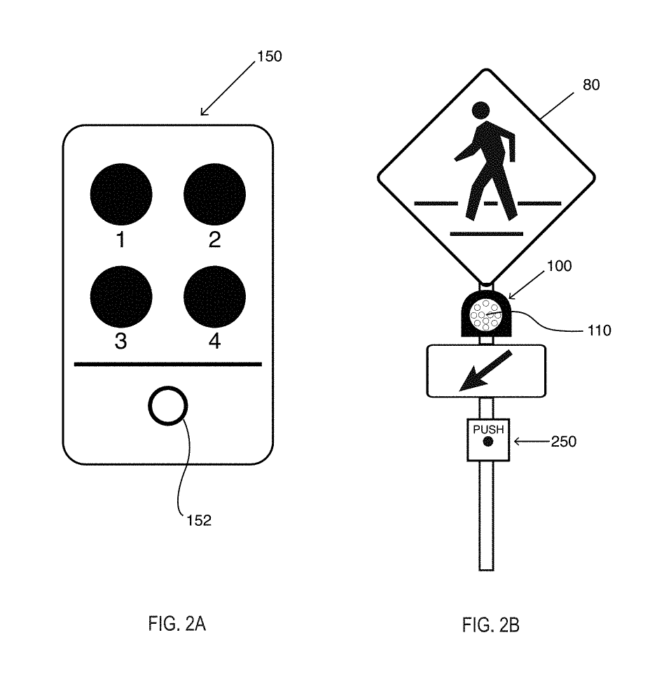

FIG. 2A depicts a remote control 150 according to some embodiments that may be used to operate one or more of the crosswalk safety modules, such as crosswalk safety module 100. Remote control 150 may be wireless, and may comprise a plurality of buttons or other actuation elements, such as switches, knobs, dials, or other such elements used to operate the crosswalk safety module(s). For example, as shown in FIG. 2A, wireless remote control 150 comprises four buttons, each of which may correspond with a separate crosswalk safety module. In some embodiments, a master button 152 or other actuation element may be used to allow for operation of each of the various crosswalk safety modules of a safety system for enhancing the visibility of pedestrian crosswalk traffic control devices separately. In this manner, a user may be allowed to either separately actuate each device or actuate each of a plurality of such devices, depending upon the desired application.

Alternatively, each of the various buttons of remote control 150 may correspond with a different program or function that may be associated with each of a plurality of crosswalk safety modules. For example, button 1 may be used to actuate lights only, button 2 may be used to actuate lights and sound, button 3 may be used to initiate a first timed actuation (which may countdown and automatically shut down after a predetermined time period), and button 4 may be used to initiate a second timed actuation, which may differ in duration or otherwise from the first timed actuation (such as providing lights and sound instead of just lights, adjusting the color of the lights, adjusting the volume of the sounds, etc.).

For example, if less than all of the crosswalk safety modules of a given system are needed, such as due to the size of a particular crosswalk, the modules may be operated separately. However, the user may have the option of actuating each of the various crosswalk safety modules together if desired such that an entire set of crosswalk safety modules, and/or an entire “zone” of such modules, as discussed below, may be actuated together.

In some embodiments, some of the various buttons/actuation elements of remote control 150 may be configured as “zone toggle” buttons/actuation elements. In other words, one or more crosswalk safety modules may be linked with a particular crosswalk or portion of a crosswalk (either of which may be considered a “zone” as this term is used herein) and thus a particular button/actuation element may be linked with each such zone to allow for operation of each crosswalk safety module linked with that particular zone. In preferred embodiments, remote control 150 operates via radio frequency (RF), an application software (app), and/or or other similar means. Thus, as described below, each crosswalk safety module may be equipped with various receivers/transceivers, or other means, to enable multiple units to be controlled independently, or concurrently, by the same remote control 150.

FIG. 2B depicts an alternative remote control 250 according to other embodiments. Remote control 250 is coupled with a fixed pedestrian crosswalk sign 80. Remote control 250 may be configured to also be coupled with pedestrian crosswalk sign 80 or another traffic control device. In some embodiments, remote control 250 may be configured to be removably coupled with pedestrian crosswalk sign 80 or another traffic control device along with crosswalk safety module 100. Remote control 250 may have a plurality of buttons/actuation elements, as previously described or, alternatively, may comprise a single button/actuation element, as depicted in FIG. 2B. Although it is still preferred that remote control 250 be wireless, in embodiments in which remote control 250 is configured to operate only a single crosswalk safety module 100, it is contemplated that remote control 250 may comprise a wire or be an integral part of the crosswalk safety module 100. However, as previously described, in some embodiments remote control 250 may be configured to operate a plurality of separate crosswalk safety modules.

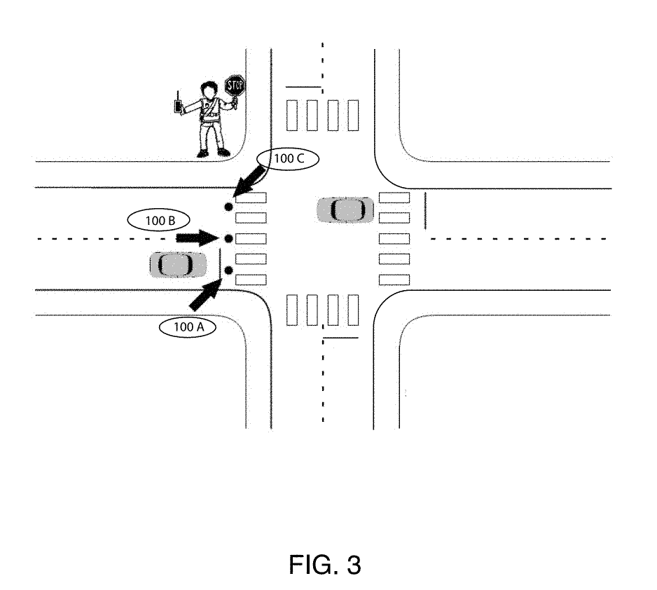

FIG. 3 depicts a crosswalk zone having a plurality of crosswalk safety modules 100A, 100B, and 100C arranged along one of the crosswalks of the crosswalk zone. In some implementations of inventive methods using one or more of the embodiments disclosed herein, a user, in anticipation of pedestrians, may place one or more crosswalk safety modules 100 on cones or other traffic control devices in or near a crosswalk zone. Prior to pedestrians entering a crosswalk zone, a user may activate each of the various crosswalk safety modules 100, or each of the various crosswalk safety modules 100 in a particular zone, by actuating a remote control 150 or, alternatively, by actuation of a button or other actuation element on the crosswalk safety modules 100 themselves. This may result in activation of all units that are programmed alike. In preferred embodiments, multiple crosswalk safety modules 100 may be programmed alike or otherwise functionally coupled with one another such that, when used simultaneously, a visual delineation line or barrier is created between the crosswalk safety modules 100, thereby increasing visibility and safety.

In some embodiments and implementations actuated by a button or other actuation element on the crosswalk safety modules 100 themselves, a master crosswalk safety module 100 may be activated, which may result in activation of a plurality of corresponding slave units programmed like the master unit.

A user may deactivate the crosswalk safety module(s) 100 by re-pressing/actuating the remote control 150 or other button/actuation member. Alternatively, the units may be programmed with various timers or other options for activation and de-activation, as described in greater detail below. In some embodiments and implementations, a deactivation sequence may result in a wireless receiver or other element of the various units to cease providing power to a control module or other element of the various units, which may deactivate the audible and/or visual notifications, such as speakers and lights.

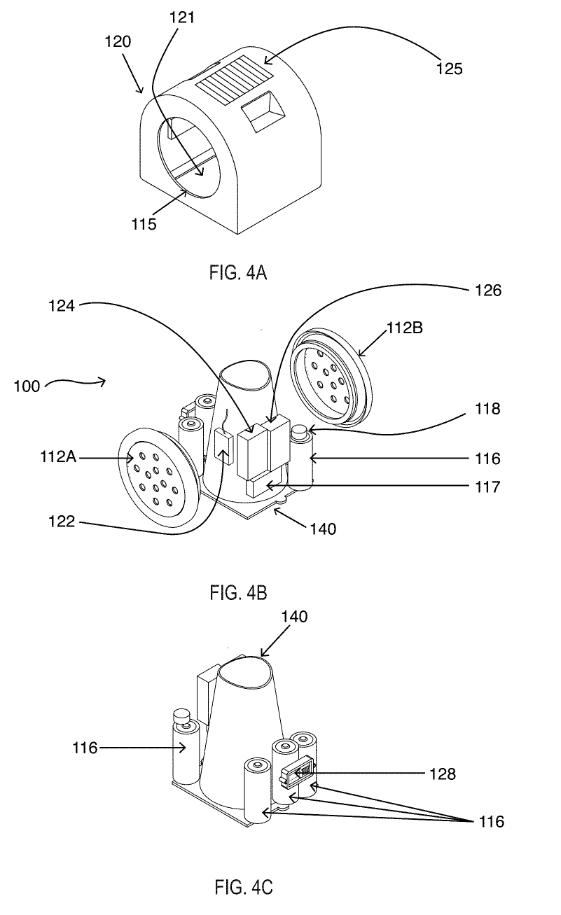

FIG. 4A is a perspective view of a housing 120 of a crosswalk safety module according to some embodiments. Housing 120 comprises a side opening 115, which may be configured to receive a light and/or light assembly, which may include one or more light elements, such as light emitting diode (LED) light elements, strobe lighting elements, such as a stroboscopic lamp, LASER light elements, or the like. As described in greater detail below, in some embodiments, such light elements may be positioned on multiple sides of the device.

In addition, such light elements may be configured to flash, or be configured to selectively flash by a user, and may be configured to allow a user to adjust the color, intensity, flashing, flash rate, pattern, and/or color sequencing. For example, some embodiments may be configured to illuminate and/or flash in a first color, such as amber, for a first predetermined time period, and then may be configured to transition to another color, such as red, for a second predetermined time period. Some embodiments may be configured with a preset functionality such that a user may actuate a particular function/sequence with the single touch of a button or other actuation element. Some embodiments may be configured to allow a user to select from a variety of preset functions/sequences, each of which may be actuated with a separate button/actuation element. Some embodiments may be configured to allow a user to program a desired function/sequence and associate such function/sequence with a particular button or other actuation element.

Although not visible in FIG. 4A, housing 120 may comprise one or more additional light assembly openings, such as another opening opposite from opening 115, such that multiple lights directed in different directions may be used. This may be useful to provide visual notification to vehicles in two opposing directions at or near a crosswalk.

Housing 120 is illustrated as a semi-cubical housing having a rounded upper end and a flat lower end and configured to receive one or more round lights 110 or light assemblies. However, a wide variety of shapes and sizes may be used depending upon the desired application and the type of traffic control device(s) to which the housing is configured to be coupled. Housing 120 and/or lights/light assemblies 110 are preferably made up of a light-weight, crash-resistant type of material, which, if hit by an errant vehicle, are not likely to cause injury or damage. Such materials are also preferably durable, lightweight, rust and corrosion resistant, such as a polymer or similar type material.

Preferably, housing 120 is water-tight or at least water resistant so that the internal components are not impacted by adverse weather conditions. As described below, various modular adapters may be used to allow a particular crosswalk safety module to be firmly coupled with various traffic control devices, such as traffic cones, signs, guardrails, poles, etc.

Preferably, housing 120, or at least a large portion of housing 120, is provided with a bright, easily noticeable color or colors, such as orange, red, or yellow. In some embodiments, housing 120 may be provided with a partially or fully reflective material, or may be provided with reflective patches for enhancing visibility.

Housing 120 further comprises a bottom opening 121. As described in greater detail below, bottom opening 121 may be configured to receive one or more modular coupling elements for coupling a crosswalk safety module with a crosswalk traffic control device, such as a traffic cone, a portable traffic delineator tube, a portable pedestrian crosswalk sign, or a fixed pedestrian crosswalk sign. Some embodiments may be configured to receive a plurality of distinct modular coupling elements for coupling with different types of crosswalk traffic control devices. Alternatively, bottom opening 121 may be configured to directly receive and/or allow for coupling with one or more crosswalk traffic control devices without use of a modular coupling element.

Housing 120 further comprises a solar panel 125. Solar panel 125 is preferably coupled with one or more batteries so as to store electrical energy generated from the solar panel for use when direct solar energy is unavailable or limited.

FIG. 4B is a perspective view depicting various internal components of a crosswalk safety module 100 according to some embodiments. Crosswalk safety module 100, including the internal elements depicted in this figure, may be used in connection with housing 120. As illustrated in the figure, each crosswalk safety module 100 may comprise one or more light assemblies 110 (light assemblies 110A and 110B are shown on opposite sides of the device), each of which may each comprise one or more lenses, one or more light elements, such as LED lights or another suitable lights, and/or other elements such as frames, housings, etc.

Each crosswalk safety module 100 may further comprise one or more batteries 116. A battery management board 117 may be provided to control various aspects of delivery of energy from, and, in embodiments comprising rechargeable batteries, to, each of the various batteries 116. In embodiments comprising a solar panel 125, battery management board 117 may also be configured to control delivery of electrical power from solar panel 125 and/or allow for charging of batteries 116 when excess solar energy is available. Battery management board 117 may further be configured to protect batteries 116, such as by ensuring that each of the batteries 116 operates within desired operation parameters and/or by facilitating optimization of batteries 116. In some embodiments, battery management board 117 may comprise a printed circuit board (PCB), circuitry, a microprocessor, and/or other suitable components, as those of ordinary skill in the art will appreciate, for controlling the flow of electricity to and/or from batteries 116.

Each crosswalk safety module 100 may further comprise an audible alarm element 118, such as a piezoelectric alarm/buzzer, a speaker, or another suitable element configured to deliver an audible notification, which in some embodiments may be linked with the visual notification provided by lights 110. For example, some embodiments may be configured to deliver a pulsed or intermittent audible alarm/notification that may correspond with a pulsed or intermittent visual notice provided by lights 110.

A receiver and/or transceiver 122, which may comprise an antenna and suitable electronics for receipt and/or transmission of wireless signals, may also be provided in order to allow for wireless communication with a remote control, such as remote control 150 or remote control 250. Receiver/transceiver 122 may be configured to operate using any suitable wireless communication technologies, including radio-frequency (“RF”), Near Field Communication (“NFC”) standards, IEEE's 802.11 standards, Bluetooth®, ultra-wide band (“UWB”), Zigbee®, radio-frequency identification (“RFID”), and or any other suitable wireless communication protocols or combinations thereof. As mentioned above, in alternative embodiments, the crosswalk safety module(s) 100 may operate via wired remote control, or via buttons or other actuation elements positioned directly on housing 120 or otherwise on the crosswalk safety modules 100 themselves.

A light control module 124 may be provided to allow for basic operational control of the one or more light elements. For example, light control module 124 may comprise a controller that is configured to allow a user to select between various lighting parameters, such as the color, blinking vs. continuous light, duration of blinks, time between blinks, etc.

A second control module may be provided in some embodiments. Thus, the depicted embodiment of FIGS. 4B and 4C further comprises a programming module 126. Programming module 126 may comprise a controller, microprocessor, memory, and/or suitable electrical circuitry and may be configured to allow for more advanced control/programming options. For example, programming module 126 may allow for separate control of audible alarm element 118 including, for example, the volume of the alarm, continuous vs. intermittent sounds, the duration of the sounds, time between sounds, etc. In some embodiments, one or more of the various operational parameters of the audible alarm element 118 may be linked with those of the lights 110. For example, the audible alarm from audible alarm element 118 may be linked with the lights 110 of the crosswalk safety modules 100 such that each blink of light(s) 110 corresponds with an audible tone from audible alarm element 118.

As another example, programming module 126 may allow a user to set a timer for one or both of the visual and audible notifications provided by the crosswalk safety modules 100. This timer option may allow a user to set a time of the day and duration of operation such that the crosswalk safety module(s) 100 may operate without an operator during a desired time period. Alternatively, or additionally, programming module may allow a user to set a timer in terms of duration only and then actuate the device(s) and have them automatically shut off after the predetermined duration.

One or both of modules 124 and 126 may also, in some embodiments, be configured to allow for providing a countdown function. In other words, a user may be able to initiate a countdown process, either manually by pressing a button or other actuation element—either on the crosswalk safety module 100 or on the remote control 150—or by operation of a programmed timer or automatic detection, such as by detecting the presence of a pedestrian, which may result in audible and/or visual countdown features for a predetermined time period. This may be useful to allow for activation of one or more features of the crosswalk safety modules 100 only during particular times, such as when pedestrians are crossing or about to cross a crosswalk. In some embodiments, the duration of the predetermined time period associated with such countdown procedures may be selected/programmed by a user.

As also shown in FIG. 4B, crosswalk safety module(s) 100 may further comprise a coupling element 140 configured to facilitate coupling of the crosswalk safety module 100 with a crosswalk traffic control device. In the depicted embodiment, coupling element 140 comprises a conical frame, which may be configured to receive a conical projection, such as a traffic cone, therein, as illustrated in FIG. 1A. In some embodiments, the coupling element 140 may also serve as an internal framework for mounting one or more of the various internal components thereto, as generally illustrated in FIGS. 4A and 4B.

In some embodiments, coupling element 140 may be removable and replaceable with a distinct coupling element configured to couple the crosswalk safety module with a distinct type of crosswalk traffic control device. Such coupling elements are referred to herein as “modular coupling elements” for coupling the crosswalk safety module(s) with one of a plurality of distinct crosswalk traffic control devices.

FIG. 4C is a second perspective view of the internal components of FIG. 4B taken from a side opposite to the side depicted in FIG. 4B. As illustrated in FIG. 4C, a battery gauge 128 may also be provided. Battery gauge 128 may be configured to provide a visual and/or audible notification of one or more parameters of the one or more batteries 116 of the crosswalk safety module 100, such as the remaining energy left in the batteries 116.

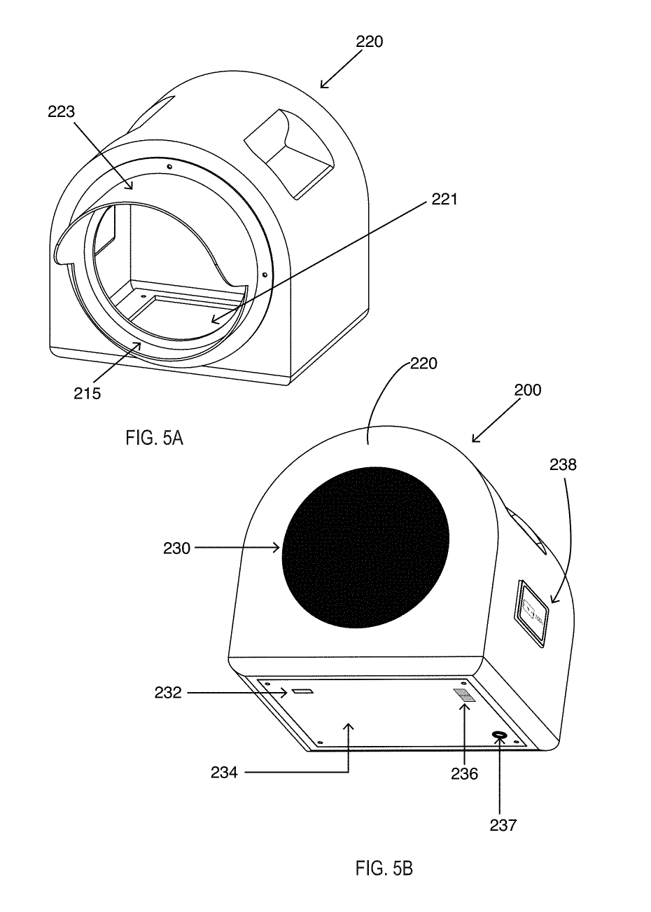

FIG. 5A is an upper perspective view of a housing 220 of a crosswalk safety module 200 according to other embodiments. FIG. 5B is a lower perspective view of housing 220. Housing 220 is similar to housing 120 with a few exceptions. First, housing 220 comprises a visor 223, which may be configured to reduce glare and/or improve the visibility of the light generated from within opening 215.

In addition, housing 220 comprises a lower opening 221. As shown in FIG. 5B, lower opening 221 may be configured to be coupled with a plate or cover 234. In addition, a magnet 230 is positioned on the side of housing 220 opposite from opening 215. Magnet 230 may allow the housing 220 to be removably coupled with a metallic element of a traffic control element, such as a fixed traffic sign. However, alternative embodiments are contemplated in which opening 221 may be left open in order to allow for housing 220 to be placed upon or otherwise coupled with another suitable traffic control device. In some such embodiments, the inside of housing 220 may be shaped or otherwise configured to mate with or otherwise suitably receive/couple with such a device.

As also shown in FIG. 5B, crosswalk safety module 200 further comprises a battery gauge 238, as previously discussed, along with an on/off indicator light 232, and on/off switch 236, and a charging port 237, which may allow for charging of the internal batteries (not shown) by electrical outlet rather than solar power. Although several of these elements are shown positioned on cover 234, those of ordinary skill in the art will appreciate that these elements may be positioned elsewhere on the crosswalk safety module 200 as desired. Although the internal components of crosswalk safety module 200 are not shown, it should be understood that any of the various components described elsewhere herein may be included as needed.

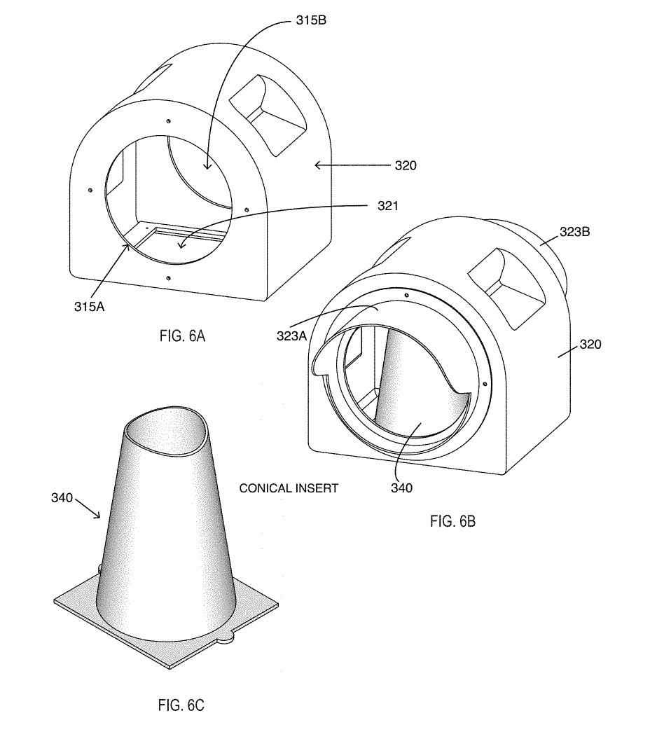

FIG. 6A is a perspective view of another housing 320 of a crosswalk safety module according to still other embodiments. FIG. 6B is a perspective view of housing 320 including opposing visors 323A and 323B and a modular coupling element 340 comprising a conical insert. FIG. 6C is a perspective view of modular coupling element 340.

Housing 320 is configured to receive two separate lighting assemblies (not shown) on opposite sides of housing 320. Thus, a first opening 315A is provided on a first side of housing 320 and a second opening 3156 is provided on a second side of housing 320 opposite from first opening 315A. In addition, a lower opening 321 is provided. Lower opening 321 and the inside of housing 320 may be configured to receive modular coupling element 340. As mentioned above, modular coupling element 340 comprises a conical insert, which insert may be specifically configured to receive and allow the corresponding crosswalk safety module to be coupled with a specific type of traffic control device (in this case a traffic cone). In some embodiments, the base of modular coupling element 340 may serve as a cover/plate and may be configured to be locked into place over opening 321, such as by way of a latch, pin, friction fit, or other suitable means.

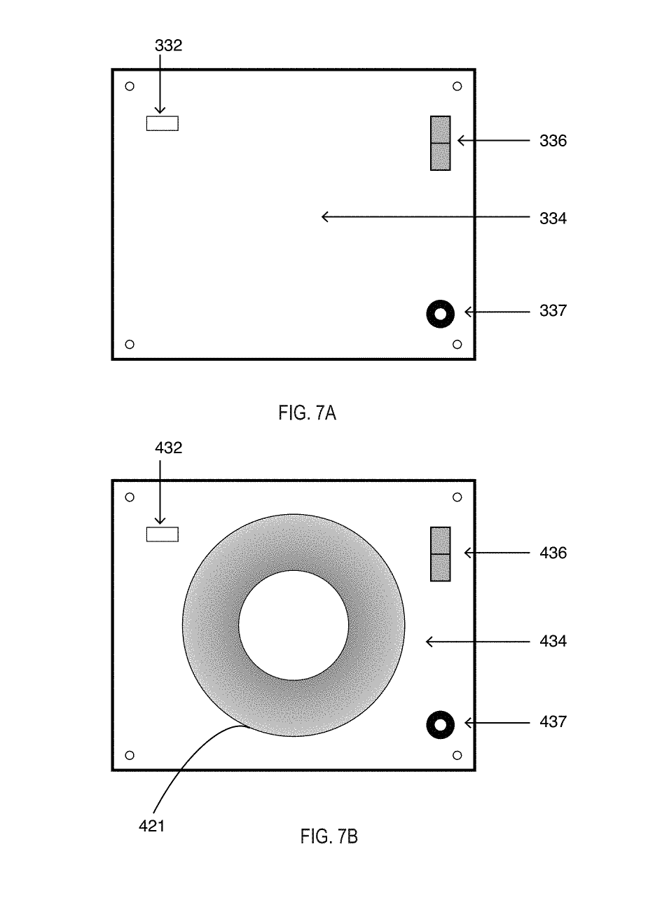

FIG. 7A is a bottom plan view of an embodiment of a crosswalk safety module. This view may, for example, correspond with the bottom surface of the base of modular coupling element 340 or, alternatively, may correspond with the bottom surface of another cover/plate, such as cover 234. As previously mentioned, various operational control elements and/or status/dashboard elements may be positioned on the bottom surface if desired. For example, the embodiment depicted in FIG. 7A comprises a cover 334 and/or lower surface comprising an on/off indicator light 332, an on/off switch 336, and a charging port 337.

FIG. 7B is a bottom plan view of yet another alternative embodiment of a crosswalk safety module. Cover 434 comprises an opening 421 for receipt of a modular coupling element and/or a crosswalk traffic control device and, like cover 334, further comprises an on/off indicator light 432, an on/off switch 436, and a charging port 437.

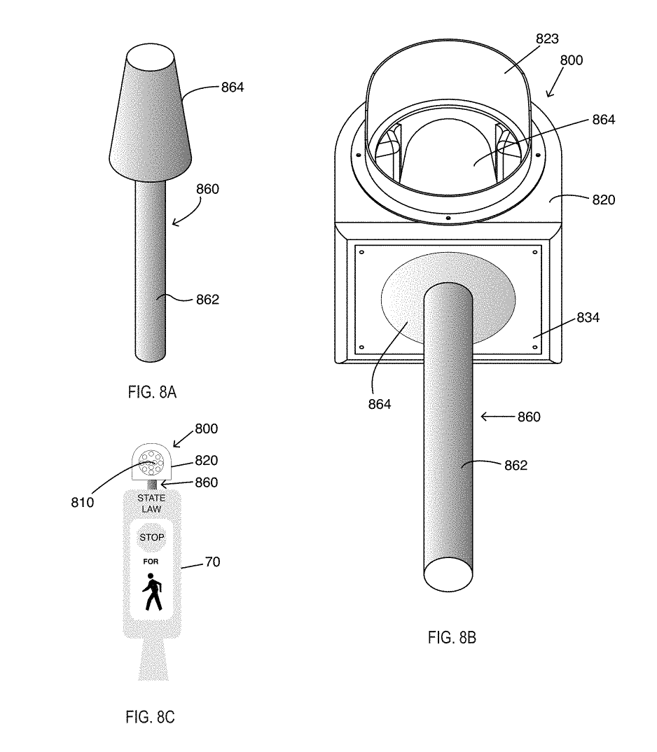

FIG. 8A is a perspective view of an alternative modular coupling element 860. Modular coupling element 860 may be used as an adapter to facilitate coupling of a crosswalk safety module with a traffic control device. More particularly, because modular coupling element 860 comprises a tubular base 862 and a conical top portion 864, modular coupling element 860 may be configured to be received in an opening of a crosswalk safety module configured to receive, for example, the conical upper portion of a traffic cone. Thus, without modular coupling element 860, a crosswalk safety module, such as crosswalk safety module 800 shown in FIG. 8B, may be configured to couple with a traffic control element comprising a traffic cone and, by coupling modular coupling element 860 with crosswalk safety module 800, as shown in FIG. 8B, crosswalk safety module may instead be configured to couple with an alternative traffic control element, such as pedestrian crosswalk sign 70, as shown in FIG. 8C. More particularly, the tubular base 862 may be slid over a corresponding rod of pedestrian crosswalk sign 70 (or tubular base 862 may be slid into a corresponding tubular portion of a rod of pedestrian crosswalk sign 70), as shown in FIG. 8C, such that light 810 faces towards the oncoming traffic.

As previously described, crosswalk safety module 800 may further comprise a housing 820, a visor 823, and a lower plate 834 having an opening for receipt of conical portion 864 of modular coupling element 860. Preferably, the internal portion of housing 820 comprises a similar conical shape such that conical portion 864 mates with the inside of housing 820. A variety of alternative shapes and configurations are contemplated, and should be apparent to those of ordinary skill in the art after having received the benefit of this disclosure.

Each of coupling element 140, magnet 230, removable conical insert 340, and modular coupling element 860 are examples of means for removably coupling a crosswalk safety module, or a portable housing of a crosswalk safety module, with a crosswalk traffic control device. Each of the modular coupling elements described herein, including modular/removable conical insert 340 and modular coupling element 860, are examples of removable or modular means for removably coupling a crosswalk safety module, or a portable housing of a crosswalk safety module, with a crosswalk traffic control device.

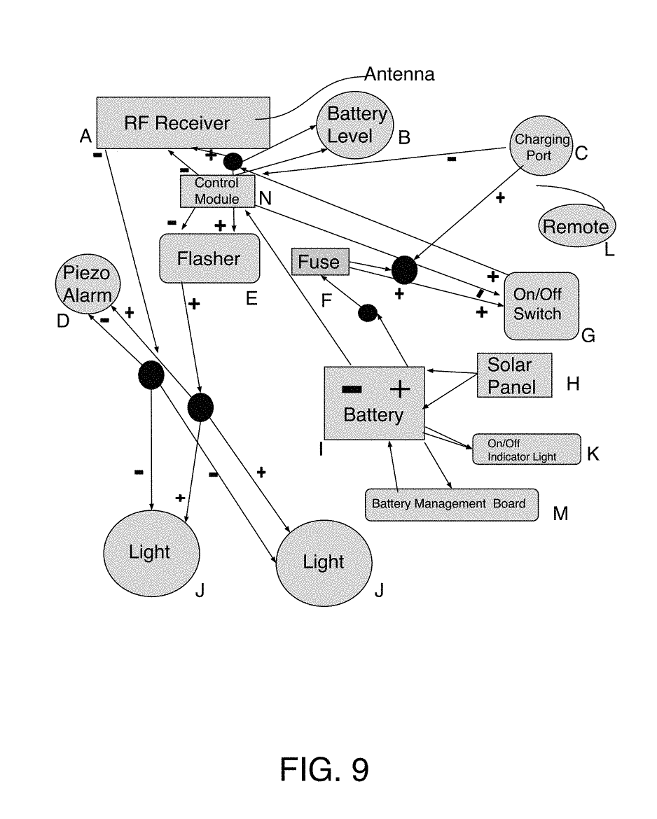

FIG. 9 is a schematic diagram illustrating the various components and wiring schematics of certain preferred embodiments. Battery I may be charged via charging port C and/or solar panel H. Energy may be transferred from solar panel H and/or from a power outlet coupled with charging port C to battery I. The current strength of the battery I (or plurality of batteries) may be displayed on a power indicator or other gauge, such as battery gauge 238. A battery management board M may be used to control the delivery of electrical energy to and/or from battery I. Positive and negative leads from battery I may be directed to on/off switch G.

Upon switch G being activated to its “on” position, power may be transferred to receiver A and on/off indicator light K may be activated. Receiver A may comprise an RF receiver having an antenna, as indicated in FIG. 9., or another receiver configured to receive signals based upon suitable alternative communication technologies. Upon a user activating a remote control L and/or an on/off switch G, power may be transferred from receiver A to flasher E and/or control module N. Based on pre-designed/programmed functions, flasher E and/or control module N may then activate piezo alarm D and/or another speaker or alarm and/or one or more lights J.

In some embodiments, flasher E may generally correspond in structure and/or function with light control module 124 and control module N may provide additional, more complex features or functions, and may therefore generally correspond in structure and/or function with programming module 126. Thus, in some embodiments, various basic lighting and/or sound parameters, such as the color, blinking vs. continuous light/sound, duration of blinks/sound, time between blinks/alarms, etc., may be provided by flasher E and other more complex parameters, such as setting timers for one or both of the alarm D and light(s) J notifications may be provided by programming module 126. Various fuses F may also be provided as needed.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present invention should, therefore, be determined only by the following claims.

1. A safety system for enhancing the visibility of pedestrian crosswalk traffic control devices, comprising:
a portable housing configured to be removably coupled with a crosswalk traffic control device;
a light coupled with the portable housing, wherein the light is configured to, upon actuation, improve the visibility of the crosswalk traffic control device to motorists;
a remote control configured to generate a signal for remote operation of the light;
a receiver configured to receive a signal from the remote control for remote operation of the light; and
a control module operably coupled with the receiver, wherein the control module is configured to receive a signal from the receiver to control operation of the light.

2. The safety system of claim 1, further comprising means for removably coupling the portable housing with a crosswalk traffic control device.

3. The safety system of claim 2, wherein the means for removably coupling the portable housing with a crosswalk traffic control device comprises at least one of a recess formed in the portable housing that is configured to allow for receipt of an upper portion of a traffic cone to be received therein, a magnet configured to allow the portable housing to be removably coupled with a metallic traffic sign, and a tubular extension to the portable housing configured to be received either in or over a pipe of a traffic sign.

4. The safety system of claim 1, wherein the portable housing is configured to be removably coupled with a plurality of distinct crosswalk traffic control devices.

5. The safety system of claim 4, further comprising a plurality of modular coupling elements, wherein each of the plurality of modular coupling elements is configured to facilitate coupling the portable housing with one of the plurality of distinct crosswalk traffic control devices.

6. The safety system of claim 5, wherein one of the plurality of modular coupling elements comprises a tubular extension configured to be removably coupled with the portable housing, and wherein the tubular extension is configured to be received either in or over a pipe of a traffic sign.

7. The safety system of claim 1, further comprising:
a solar panel; and
a battery coupled with the solar panel so as to store electrical energy generated from the solar panel.

8. A safety system for enhancing the visibility of pedestrian crosswalk traffic control devices, comprising:
a plurality of crosswalk safety modules, wherein each of the plurality of crosswalk safety modules is configured to be removably coupled with a separate crosswalk traffic control device, and wherein each of the plurality of crosswalk safety modules comprises a light configured to, upon actuation, improve the visibility of a crosswalk traffic control device coupled with the accompanying crosswalk safety module to motorists; and
a remote control configured to generate a signal for remote operation of each of the plurality of crosswalk modules, wherein each of the plurality of crosswalk modules is configured such that actuation of the remote control results in coordinated operation of the lights associated with the plurality of crosswalk modules.

9. The safety system of claim 8, wherein the safety system is configured such that the lights of the plurality of crosswalk safety modules actuate simultaneously.

10. The safety system of claim 9, wherein the safety system is configured such that the lights of the plurality of crosswalk safety modules blink together in a coordinated manner.

11. The safety system of claim 9, wherein the safety system is configured such that the lights of the plurality of crosswalk safety modules blink sequentially.

12. The safety system of claim 8, wherein each of the plurality of crosswalk safety modules comprises means for removably coupling the crosswalk safety module with a crosswalk traffic control device.

13. The safety system of claim 12, wherein the means for removably coupling the crosswalk safety module with a crosswalk traffic control device comprises at least one of a recess formed in each of the plurality of crosswalk safety modules that is configured to allow for receipt of an upper portion of a traffic cone to be received therein, a magnet configured to allow the crosswalk safety module to be removably coupled with a metallic traffic sign, and a tubular extension to the crosswalk safety module configured to be received either in or over a pipe of a traffic sign.

14. A method for improving the safety of pedestrian crosswalks, the method comprising the steps of:
coupling a first crosswalk safety module with a first crosswalk traffic control device;
coupling a second crosswalk safety module with a second crosswalk traffic control device; and
remotely actuating the first crosswalk safety module and the second crosswalk safety module using a single remote control device, wherein the step of remotely actuating the first crosswalk safety module and the second crosswalk safety module using the single remote control device results in activation of at least one of an audible alert and a visible alert from the first crosswalk safety module and the second crosswalk safety module.

15. The method of claim 14, wherein the at least one of an audible alert and a visible alert of the first crosswalk safety module is coordinated with the at least one of an audible alert and a visible alert of the second crosswalk safety module.

16. The method of claim 15, wherein the at least one of an audible alert and a visible alert of the first crosswalk safety module is simultaneous with the at least one of an audible alert and a visible alert of the second crosswalk safety module.

17. The method of claim 15, wherein the at least one of an audible alert and a visible alert of the first crosswalk safety module is sequential with the at least one of an audible alert and a visible alert of the second crosswalk safety module.

18. The method of claim 14, wherein the first crosswalk traffic control device comprises a first portable crosswalk traffic control device, and wherein the second crosswalk traffic control device comprises a second portable crosswalk traffic control device.

19. The method of claim 18, further comprising:
positioning the first portable crosswalk traffic control device along a crosswalk; and
positioning the second portable crosswalk traffic control device along the crosswalk separate from the first portable crosswalk traffic control device.

20. The method of claim 14, further comprising:
removing the first crosswalk safety module from the first crosswalk traffic control device;
coupling a modular coupling element with the first crosswalk safety module; and
coupling the first crosswalk safety module with a third crosswalk traffic control device distinct from the first crosswalk traffic control device using the modular coupling element.
